(19) United States
(12) Patent Application Publication
(10) Pub. No.: US 2026/0217045 A1
(43) Pub. Date: Jul. 30, 2026

(54) GRAVURE PRINTING CYLINDER FOR PRINTING OF LARGE-SIZED TAGS

(71) Applicant: Capsugel Belgium N.V., Bornem (BE)

(72) Inventors: Bart Verwilghen, Bornem (BE); Kris van den Abeele, Bornem (BE); Hilde Buydts, Bornem (BE)

(21) Appl. No.: 19/148,787

(22) PCT Filed: Jan. 17, 2024
(86) PCT No.: PCT/EP2024/051021

§ 371 Date: Jul. 17, 2025

(30) Foreign Application Priority Data
Jan. 19, 2023 (EP) 23152497.6
Nov. 17, 2023 (EP) 23210753.2

(51) Int. Cl. B41N 1/16; B23K 26/352; B41C 1/05; B41F 13/11; B41M 1/10; B41M 1/40; C09D 11/037

(52) U.S. Cl. CPC B41N 1/16; B23K 26/352; B41C 1/05; B41F 13/11; B41M 1/10; B41M 1/40; C09D 11/037

(57) ABSTRACT

The invention discloses a gravure printing cylinder having engravings suited for gravure printing of large-sized tags.

### REFERENCE TO PENDING PRIOR PATENT APPLICATIONS

This patent application is a 371 national stage entry of pending prior International (PCT) Patent Application No. PCT/EP2024/051021, filed 17 Jan. 2024 by Capsugel Belgium N.V. for GRAVURE PRINTING CYLINDER FOR PRINTING OF LARGE-SIZED TAGS, which patent application, in turn, claims benefit of European Patent Application No. 23152497.6, filed 19 Jan. 2023; and European Patent Application No. 23210753.2, filed 17 Nov. 2023.

The three (3) above-identified patent applications are hereby incorporated by reference.

### FIELD OF THE INVENTION

The invention discloses a gravure printing cylinder having engravings suited for gravure printing of large-sized tags.

### BACKGROUND OF THE INVENTION

Packaged items need to be labelled and authenticated, for example against counterfeiting.

EP 2513654 B1 discloses optical micro tags of porous silica which are difficult to reproduce and to read without specialized equipment.

WO 2011/159338 A1 discloses the use of said micro tags in a system for verifying an item in a package comprising a package producer and a verifier; the package producer produces a package with an item, wherein the item has one or more of said micro tag identifiers that are placed in a location on the item; the verifier verifies the item using i.a. 1) the one or more said micro tag identifiers as detected using a spectral measurement or 2) a location or a shape of the one or more tag identifiers on the item.

US201110068509 A1 according to its abstract discloses a method for manufacturing intaglio printing plates for the production of security papers, wherein a laser beam (2) is used to engrave intaglio printing patterns (3, 3.1, 3.2, 3.3) directly into the surface of a laser-engravable, especially metallic, printing plate medium (1), wherein laser engraving of the printing plate medium (1) is carried out layer by layer in several individual engraving steps performed one after the other in register so that the intaglio printing patterns (3, 3.1, 3.2, 3.3) are gradually engraved into the surface of the printing plate medium (1) up to desired engraving depths

Micro tags have the advantage of being either too small for detection by the human eye, or they are at least so small that no meaningful details can be discerned, both contributes for example to effective anti counterfeiting.

On the internet page of TruTag Technologies, Inc., Honolulu, 96826 USA, a size range for tags of from 50 to 100 μm is disclosed that can be decoded both by proprietary TruTag readers and by mobile phones. In videos on this internet page the application technology of spraying is shown: the tags can be applied by spraying them onto an object. Spraying is an application technology which is rather unspecific and non-discriminatory with regard to distribution, amount or location on the object of the sprayed tags; spraying invariably involves a waste of sprayed product due to so-called overspray.

Neither of the two disclosures EP 2513654 B1 and WO 2011/159338 A1 give specific details about how to apply the micro tags onto a surface and how to label a surface with micro tags, respectively.

Gravure printing is a long know printing technique using gravure printing cylinders having engraved on their surface an engraved pattern that is to be printed. Gravure printing is a transfer process which is selective with regard to transferred amount and location. But when using known engraved patterns on gravure cylinders for printing a printing ink containing said micro tags, the transfer of the micro tags from the ink reservoir onto the gravure printing cylinder and then the transfer from the gravure printing cylinder onto the surface which is to be imprinted causes problems.

Conventional and known engravings on gravure printing cylinders usually have a largest lateral extension of up to 150 μm. Large-sized tags contained in a gravure printing ink are either not taken up at all by such engravings or not in a sufficient quantity, so the quantity of large-sized tags transferred onto the surface of a print substrate is not sufficient to be read out by a build-in camera of a mobile phone.

When the size of the engravings is increased beyond the size common for engravings common on gravure printing cylinders then the quality of the printed pattern on the surface of the print substrate deteriorates, a fuzzy, blurred and/or smeared printed pattern is obtained, especially on the side of the engraved area which is opposite to the printing direction.

There was a need for an improved gravure printing cylinder that allows printing of micro tags in a reproducible and high quality manner, especially printing of large-sized micro tags.

Unexpectedly, having conventional engravings abutting large-sized engravings provides both an uptake and transfer of a sufficient quantity of large-sized tags by the gravure printing cylinder and a printed pattern containing large-sized tags with acceptable print quality showing either no blurred borders or at least borders which are only blurred to a still acceptable extent, especially on the side of the engraved area which is opposite to the printing direction.

The problem was solved with a certain type of engravings on the gravure printing cylinder.

The terms micro tag and tag are used interchangeably herein.

### SUMMARY OF THE INVENTION

Subject of the invention is a gravure printing cylinder for printing a gravure printed pattern containing large-sized tags onto a surface of a print substrate;

the pattern to be gravure printed is engraved into the surface of the gravure printing cylinder as an engraved pattern comprising two areas,
an area for gravure printing, AREA-NORM, and
an area for gravure printing of large-sized tags, AREA-TAG;
AREA-NORM is an area which is delimited by its border;
AREA-TAG is an area which is delimited by its border;
AREA-NORM comprises an engraving, ENGRAVING-NORM;
AREA-TAG comprises an engraving, ENGRAVING-TAG;
ENGRAVING-NORM is a pit and its surrounding wall, the pit is engraved into the surface of the gravure printing cylinder leaving its surrounding wall unengraved, with the top of the wall being on the same level as the unengraved surface of the gravure printing cylinder;
the length of ENGRAVING-NORM is the length in the direction of the largest lateral extension of ENGRAVING-NORM;
the width of ENGRAVING-NORM is the largest lateral extension of ENGRAVING-NORM perpendicular to its length;
the length of ENGRAVING-NORM is equal to or larger than its width;
ENGRAVING-TAG is a large pit and its surrounding wall, the large pit is engraved into the surface of the gravure printing cylinder leaving its surrounding wall unengraved, with the top of the wall being on the same level as the unengraved surface of the gravure printing cylinder;
the length of ENGRAVING-TAG is the length in the direction of the largest lateral extension of ENGRAVING-TAG;
the width of ENGRAVING-TAG is the largest lateral extension of ENGRAVING-TAG perpendicular to its length;
the length of ENGRAVING-TAG is equal to or larger than its width;
the length of the large pit (2-1-3) of ENGRAVING-TAG (2-1) is the length in the direction of the largest lateral extension of the large pit (2-1-3) of ENGRAVING-TAG (2-1);
the width of the large pit (2-1-3) of ENGRAVING-TAG (2-1) is the largest lateral extension of the large pit (2-1-3) of ENGRAVING-TAG (2-1) perpendicular to its length;
the length of the large pit (2-1-3) of ENGRAVING-TAG (2-1) is equal to or larger than its width;
any lateral dimension is a dimension in a cylindrical layer coaxial to the unengraved surface of the gravure printing cylinder;
characterized in that the width of ENGRAVING-NORM is less than 0.4 mm;
the lower limit of the width of ENGRAVING-TAG is 0.4 mm;
the size of the width of the large pit (2-1-3) of ENGRAVING-TAG (2-1) is at least 50% of the size of the width of ENGRAVING-TAG (2-1);
at least all the parts of the border of AREA-TAG on the side of AREA-TAG that is opposite to the printing direction abut a part of the border of AREA-NORM;
the printing direction is the circumferential direction around the axis of the gravure printing cylinder in which the gravure printing cylinder revolves when printing.

### Abbreviations And Definitions

AREA-NORM area with at least one engraving, ENGRAVING-NORM, common for conventional gravure printing
AREA-TAG area with at least one engraving, ENGRAVING-TAG, for gravure printing of large-sized tags
contour the two dimensional geometry of AREA-NORM, of AREA-TAG, of ENGRAVING-NORM, of the pit of ENGRAVING-NORM, of ENGRAVING-TAG, of the large pit of ENGRAVING-TAG and of a ridge, with the directions of the two dimensions being in an imagined cylindrical layer coaxial to the unengraved surface of the gravure printing cylinder, if not explicitly stated otherwise
depth an extension in radial direction from the level of the unengraved surface of the gravure printing cylinder towards the axis of the gravure printing cylinder
ENGRAVING-NORM engraving as a pit with it surrounding wall common for conventional gravure printing
ENGRAVING-TAG engraving as a large pit with its surrounding wall
large pit The term “large pit” is a name or designation for a pit or a recess sized to receive a large-sized tag contained in a gravure printing ink, it could also be called “large-sized tag pit” or “pit for a large-sized tag”. The term serves to differentiate between a pit of ENGRAVING-NORM, which is called simply “pit” herein, and the pit of ENGRAVING-TAG, which is called “large pit” herein.
lateral a direction in an imagined layer coaxial with the unengraved surface of the cylinder
length a length in lateral direction, if not explicitly stated otherwise
longitudinal a lateral direction parallel to a respective length
pit a pit in the sense of the invention, be it the pit of ENGRAVING-NORM or the large pit of ENGRAVING-TAG, can also be called a recess
printing direction the printing direction of the print substrate is the direction into which a print substrate moves under a revolving gravure printing cylinder when being imprinted; the gravure printing cylinder has an axis and revolves around said axis in the printing direction when printing; so the printing direction of the gravure printing cylinder is the circumferential direction around the axis of the gravure printing cylinder in the direction in which the gravure printing cylinder revolves when printing. The side of AREA-TAG, which is printed first by the revolving gravure printing cylinder is called herein the side of AREA-TAG in the printing direction, whereas the side of the AREA-TAG, which is printed last by the revolving gravure printing cylinder is called herein the side of AREA-TAG opposite to the printing direction.
shape the three dimensional geometry of the surface of an object
vertical a direction perpendicular to the unengraved surface of the cylinder; the two terms “vertical” and “radial” are used synonymously herein
width a width in lateral direction and perpendicular to a length
width of a wall or ridge a width determined at the top of the wall or ridge, i.e. the side of the wall or ridge with the largest radial distance to the axis of the gravure printing cylinder, if not explicitly stated otherwise.
The apostrophe ' is used as 1000 separator (1'000).

### DETAILED DESCRIPTION OF THE INVENTION

The print substrate can be provided by any pharmaceutical or nutritional dosage form of a drug or of a foodstuff, or by a piece of foodstuff suitable for gravure printing, such as a two-piece hard capsule shell or a body or a cap of a two-piece hard capsule shell or a tablet or a piece of candy or the like; preferably, the gravure printing cylinder is adapted for printing onto a surface of such a print substrate, preferably onto a surface of a two-piece hard capsule shell or a body or a cap of a two-piece hard capsule shell or a tablet.

The print surface is the outer surface of the print substrate onto which the pattern containing large-sized tags is printed.

Preferably, the surface of a two-piece hard capsule shell or of a cap or of a body of the two-piece hard capsule shell onto which the pattern containing large-sized tags is printed, is the outer surface of the cylindrical part of the two-piece hard capsule shell or of the body or of the cap of a two-piece hard capsule shell; preferably, the surface of a tablet or of a piece of foodstuff, such as a piece of candy or the like, onto which the pattern containing large-sized tags is printed, is a cylindrical part of the tablet or of the piece of foodstuff.

The gravure printing cylinder is an engraved cylinder and can also be called gravure cylinder.

The length of the gravure printing cylinder extends in the direction of its axis.

The terms “abut”, “directly adjacent” and “directly bordering” are used herein interchangeably, that means for example that at least part of AREA-NORM and at least part of AREA-TAG abut each other or are directly adjacent to each other or directly bordering each other.

AREA-NORM is an area which is delimited by its border. AREA-NORM is the area that is defined if all ENGRAVING-NORMs of AREA-NORM are surrounded by an imaginary line which touches the ENGRAVING-NORMs located outermost in AREA-NORM and thereby connects every two adjacent ENGRAVING-NORMs located outermost in AREA-NORM. This imaginary line is the border of AREA-NORM.

Preferably the imaginary line connects every two adjacent ENGRAVING-NORMs located outermost in AREA-NORM in such a manner that the length of the imaginary line and therewith the length of the border of AREA-NORM is minimal. Thereby the connecting part of the imaginary line between every two adjacent ENGRAVING-NORMs located outermost in AREA-NORM is a straight line and connects tangentially to each of said two adjacent ENGRAVING-NORMs.

AREA-TAG is an area which is delimited by its border. AREA-TAG is the area that is defined if all ENGRAVING-TAGs of AREA-TAG are surrounded by an imaginary line which touches the ENGRAVING-TAGs located outermost in AREA-TAG and thereby connects every two adjacent ENGRAVING-TAGs located outermost in AREA-TAG. This imaginary line is the border of AREA-TAG.

Preferably the imaginary line connects every two adjacent ENGRAVING-TAGs located outermost in AREA-TAG in such a manner that the length of the imaginary line and therewith the length of the border of AREA-TAG is minimal. Thereby the connecting part of the imaginary line between every two adjacent ENGRAVING-TAGs located outermost in AREA-TAG is a straight line and connects tangentially to each of said two adjacent ENGRAVING-TAGS.

Preferably, AREA-NORM has a plurality of ENGRAVING-NORM; in an embodiment, any two adjacent ENGRAVING-NORMs abut each other, more preferably AREA-NORM has a plurality of ENGRAVING-NORM and AREA-NORM is completely filled with a plurality of ENGRAVING-NORMs with any two adjacent ENGRAVING-NORMs abutting each other.

In case that AREA-NORM is completely filled with a plurality of ENGRAVING-NORMs with any two adjacent ENGRAVING-NORMs abutting each other and the contour of ENGRAVING-NORM is a square, then a density of ENGRAVING-NORM in the AREA-NORM is preferably more than 6.25 ENGRAVING-NORMs per mm², in this case the density of ENGRAVING-NORM in the AREA-NORM is preferably from 6.25 to 1'111 ENGRAVING-NORMs per mm², more preferably from 11 to 1'111 ENGRAVING-NORMs per mm², even more preferably from 25 to 1'111 ENGRAVING-NORMs per mm², especially from 39 to 278 ENGRAVING-NORMs per mm², more especially from 44 to 204 ENGRAVING-NORMs per mm², even more especially from 48 to 178 ENGRAVING-NORMs per mm², in particular values are from 123 to 156 ENGRAVING-NORMs per mm², such as 145 ENGRAVING-NORMs per mm², or from 44 to 51 ENGRAVING-NORMs per mm², such as 49 ENGRAVING-NORMs per mm²; more in particular 145 ENGRAVING-NORMs per mm².

Preferably, AREA-TAG has only one ENGRAVING-TAG and the area of ENGRAVING-TAG and the area of AREA-TAG are identical.

Where AREA-NORM is abutting AREA-TAG, the respective part of the border of AREA-NORM and the respective abutting part of the border of AREA-TAG can be viewed as one border delimiting both areas; at least all the parts of the border of AREA-TAG on the side of AREA-TAG that is opposite to the printing direction abut a part of the border of AREA-NORM; that means that AREA-NORM in this embodiment completely covers any part of the border of AREA-TAG on the side of AREA-TAG that is opposite to the printing direction.

Having AREA-NORM abutting at least all the parts of the border of AREA-TAG on the side of AREA-TAG that is opposite to the printing direction, together with the dimensions of ENGRAVING-TAG being adapted to transferring large-sized tags onto the print substrate, provides both an uptake and transfer of a sufficient quantity of large-sized tags by the gravure printing cylinder and a printed pattern containing large-sized tags with acceptable print quality showing no blurred borders or borders which are only blurred to a still acceptable extent.

Preferably, everywhere where a part of the border of AREA-NORM abuts a part of a border of AREA-TAG, one or more ENGRAVING-NORMs abut said part of the border of AREA-NORM and any two of these one or more ENGRAVING-NORMs which are adjacent to each other abut each other; so these said one or more ENGRAVING-NORMs actually constitute said at least part of the border of AREA-NORM; more preferably, the border of AREA-NORM is constituted by a succession of ENGRAVING-NORMs where any two adjacent ENGRAVING-NORMs abut each other.

When AREA-NORM is completely filled with a plurality of ENGRAVING-NORMs with any two adjacent ENGRAVING-NORMs abutting each other, then the ENGRAVING-NORMs at the border of AREA-NORM constitute the border of AREA-NORM.

AREA-TAG can be surrounded partly by more than one AREA-NORM, preferably, AREA-NORM fully encloses and abuts AREA-TAG.

In an embodiment,
AREA-NORM is completely filled with a plurality of ENGRAVING-NORMs with any two adjacent ENGRAVING-NORMs abutting each other,
the border of AREA-NORM is constituted by a succession of ENGRAVING-NORMs abutting successively each other; and
AREA-NORM abuts and completely covers any part of the border of AREA-TAG on the side of AREA-TAG that is opposite to the printing direction; preferably, AREA-NORM fully encloses and abuts AREA-TAG.

AREA-NORM can have any contour. Parts of AREA-NORM can be at a distance from AREA-TAG without abutting AREA-TAG.

The width of those parts of AREA-NORM which are abutting AREA-TAG extends in lateral direction perpendicular to the direction of the border of AREA-NORM starting from a point, which can be called a first point and which is located on the border of the AREA-NORM where AREA-NORM abuts AREA-TAG, and extending from said first point over AREA-NORM to a second point which is on the border of AREA-NORM at the other side of AREA-NORM opposite to the first point. Said width of those parts of AREA-NORM, which are abutting AREA-TAG, is preferably at least 0.1 mm, more preferably at least 0.2 mm, even more preferably at least 0.23 mm;
typical ranges are from 0.1 to 1 mm, preferably from 0.2 to 0.75 mm, more preferably from 0.23 to 0.75 mm;
typical values are 0.24 mm, 0.375 mm and 0.6 mm.

Any width of AREA-NORM is preferably at least 0.1 mm, more preferably at least 0.2 mm;
typical ranges are preferably from 0.1 to 1 mm, more preferably from 0.2 to 0.75 mm;
typical values are in particular about 0.25 mm, or about 0.375 mm or about 0.6 mm.

In an embodiment,
AREA-TAG has only one ENGRAVING-TAG and the areas of ENGRAVING-TAG and of AREA-TAG are identical;
AREA-NORM is completely filled with a plurality of ENGRAVING-NORMs with any two adjacent ENGRAVING-NORMs abutting each other;
the border of AREA-NORM is constituted by a succession of ENGRAVING-NORMs abutting successively each other;
AREA-NORM abuts and completely covers any part of the border of AREA-TAG on the side of AREA-TAG that is opposite to the printing direction; preferably, AREA-NORM fully encloses and abuts AREA-TAG;
the width of those parts of AREA-NORM, which are abutting AREA-TAG, is preferably at least 0.1 mm, also with any of the embodiments of this width as described herein.

The wall of ENGRAVING-TAG surrounding the large pit delimits the large pit and the wraparound edge of the wall of the large pit can be called the rim of the wall of the large pit or simply the rim of the large pit herein for ease of reading; preferably the wall has the essentially same width over its whole length.

The width and the length of the wall of ENGRAVING-TAG are lateral dimensions, the width is perpendicular to the length and is preferably from 5 to 25 μm, more preferably from 10 to 20 μm, even more preferably from 12.5 to 17.5 μm; a typical value is 15 μm.

Preferably, the size of the width of the large pit of ENGRAVING-TAG is
at least 60%, more preferably at least 70%, even more preferably
at least 80%, especially at least 90%, more especially at least 93.75%, of the size of the width of ENGRAVING-TAG;

ENGRAVING-TAG and the large pit of ENGRAVING-TAG can have same, at least essentially same, or different contours, a contour may be any kind of contour, such as the contour of a square, circle, ellipse, or rectangle, preferably of a rectangle.

Preferably, ENGRAVING-TAG and the large pit of ENGRAVING-TAG have same contours or at least essentially same contours, preferably of a rectangle; essentially means that this contour refers at least to the overall contour ENGRAVING-TAG and the large pit of ENGRAVING-TAG since the detailed contour of the rim of the large pit and with the rim also the extension of the wall from the rim to the bottom of the large pit can vary or fluctuate in lateral direction back and forth on a small scale due to the specific engraving technique. Such variations or fluctuations may have the size of up to 100% or up to 75% of the width of the wall of ENGRAVING-TAG. Such variations or fluctuations may for example be present where ENGRAVING-TAG abuts a border of AREA-NORM and a succession of ENGRAVING-NORMs abutting each other constitutes the border of AREA-NORM, in this case the variations or fluctuations of the contour of the rim of the large pit can follow the contours of the succession of the ENGRAVING-NORMs.

The depth of the large pit is preferably at least 15 μm, more preferably at least 17.5 μm.

Preferably, the depth of the large pit is from 15 to 40 μm, more preferably from 17.5 to 40 μm, even more preferably from 17.5 to 35, especially from 17.5 to 32.5 μm, typical values are 20 μm, 25 μm and 30 μm.

Preferably, the large pit of ENGRAVING-TAG is a large pit with an essentially flat bottom surrounded by a wall. Essentially flat means that the engraving method aims at providing a flat bottom of the large pit, but there may be small deviations in the flatness of the bottom caused by the specific engraving technique. For example the transition from the wall to the bottom of the large pit can be a sharp and well defined 90° kink but it can also have a curved contour. The other areas of the bottom may have said small deviations in depth, these deviations are preferably up to 20%, more preferably up to 10%, even more preferably up to 7.5%, especially up to 5%, of the depth of the large pit, with the values stated herein of the depth of the large pit being an average depth of the area of the bottom of the large pit.

In a first embodiment, ENGRAVING-TAG extends with its length in the direction of the axis of the gravure printing cylinder; whereas the width of ENGRAVING-TAG extends circumferentially around the gravure printing cylinder;
in a second embodiment, ENGRAVING-TAG extends with its length in the circumferential direction around the gravure printing cylinder; whereas the width of ENGRAVING-TAG extends in the direction of the axis of the gravure printing cylinder;
the first embodiment is the preferred embodiment.

The lower limit of the width of ENGRAVING-TAG is 0.4 mm, preferably 0.45 mm or 0.6 mm or 0.7 mm.

Preferably, the upper limit of the width of ENGRAVING-TAG is 3 mm, more preferably 2.5 mm, even more preferably 2.25 mm, especially 2.1 mm.

Any of the lower limit can be combined with any of the upper limit of the width of ENGRAVING-TAG.

Preferably, the width of ENGRAVING-TAG is from 0.4 to 3 mm, more preferably from 0.4 to 2.5 mm, even more preferably from 0.4 to 2.25 mm, especially from 0.4 to 2.1 mm; typical values are 0.5 mm, 0.75 mm and 2 mm.

Preferably, the lower limit of the length of ENGRAVING-TAG is at least equal to the lower limit of the width of ENGRAVING-TAG; a lower limit of the length of ENGRAVING-TAG is therefore 0.4 mm, preferably 0.45 mm or 0.6 mm or 0.7 mm or 0.8 mm or 0.9 mm or 1 mm.

The upper limit of the length of ENGRAVING-TAG is limited either by the length or the circumference of the gravure printing cylinder, or by the respective desired extension of the area to be imprinted on the surface of the print substrate, whichever is smaller; a typical range of the length of ENGRAVING-TAG is from 1 mm to 30 mm, typical values are 2 mm, 5 mm, 10 mm and 15 mm.

The length of a closed two-piece hard capsule shell and of its two parts, the body and the cap, as an example for a possible print substrate onto which the pattern containing large-sized tags is printed, varies with the size of the two-piece hard capsule shell; typical lengths of a body and of a cap of a two-piece hard capsule shell and of a closed two-piece hard capsule shell are given in Table 1 for the two extreme sizes 000 and 5:

TABLE 1

| | | |
|---|---|---|
| Size | 000 | 5 |
| body [mm] | 22.2 | 9.3 |
| cap [mm] | 12.95 | 6.20 |
| closed capsule shell [mm] | 26.1 | 11.1 |

When the surface onto which the pattern containing large-sized tags is printed is the outer surface of the cylindrical part of a body or of a cap of a two-piece hard capsule shell, a typical length of ENGRAVING-TAG is preferably up to 21 mm, more preferably up to 20 mm, even more preferably up to 19 mm;

so for printing onto capsules a typical length of ENGRAVING-TAG is preferably from 0.4 to 21 mm, more preferably from 0.4 to 20 mm, even more preferably from 0.4 to 19 mm.

In an embodiment,
the width of the wall of ENGRAVING-TAG is from 5 to 25 μm, also with any of the embodiments of its width as defined herein;
ENGRAVING-TAG and the large pit of ENGRAVING-TAG have same contours, a contour of a rectangle;
preferably, the depth of the large pit is from 15 to 40 μm, also with any of the embodiments of its width as defined herein;
preferably, ENGRAVING-TAG extends with its length in the direction of the axis of the gravure printing cylinder;
preferably, the lower limit of the length of ENGRAVING-TAG is 0.4 mm, also with any of the embodiments of its length as defined herein.

The large pit of ENGRAVING-TAG can contain at least one ridge. Preferably, when the length of the large pit, that is its largest longitudinal extension from one wall to the opposite wall delimiting the large pit, is 500 μm or larger, preferably 550 μm or larger, more preferably 600 μm or larger, then the large pit contains at least one ridge.

A ridge is an area within the large pit which is engraved to a depth of at most 25%, preferably at most 20%, more preferably at most 15%, even more preferably at most 10%, especially at most 5%, of the depth of the large pit, especially a ridge is an area within the large pit which is not engraved. So the top of a ridge is on a slightly lower level or on the same level as the unengraved area of the gravure printing cylinder, that means the top of a ridge has a slightly lower radial distance or the same radial distance from the axis of the gravure printing cylinder as the unengraved area of the gravure printing cylinder.

Preferably a ridge extends, that is crosses through the large pit from one point of the wall of the large pit to a point of the wall on the other side of the large pit; a ridge divides the large pit into subpits.

Preferably a ridge has the contour of a straight line and it is inclined with an angle against the direction of the length of the gravure printing cylinder;

preferably, the angle of a ridge is from 15 to 75°, more preferably from 25 to 65°, more preferably from 35 to 55°, even more preferably from 40 to 50°; a typical value of the angle is 45°.

If the large pit contains more than one ridge, then preferably all ridges have the same contour; and/or
a ridge has the same width over its entire length; and/or
the width of a ridge is at least 10 μm, more preferably at least 20 μm,
even more preferably at least 25 μm; and/or
the width of a ridge is from 10 to 50 μm, preferably from 20 to 40 μm, more preferably from 25 to 35 μm; a typical value is 30 μm; and/or in case of when the large pit contains more than one ridge then all ridges have the same width.

In an embodiment, a ridge has the contour of a straight line, is inclined with an angle against the direction of the length of the gravure printing cylinder, preferably, the angle of the ridge is from 15 to 75°, and has the same width over its entire length, and,
when the large pit contains more than one ridges, then
   all ridges have the same contour;
   all ridges have the same angle, so all ridges run parallel to each other, preferably, the angle of a ridge is from 15 to 75°, also with any of the embodiments of their angle as defined herein; and
   all ridges have the same width, preferably of at least 10 μm, also with any of the embodiments of their width as defined herein.

The length of a subpit is the largest extension of the subpit in the direction parallel to a straight line that connects the start point and the end point of a ridge.

The length of a subpit is determined by the dimensions of the large pit.

The width of a subpit extends in the direction perpendicular to a ridge delimiting the subpit and is defined to be either, in case the subpit is delimited by only one ridge, the largest distance between the midpoint of the width of said ridge and the respective border of ENGRAVING-TAG delimiting said subpit, or, if the subpit is delimited by two adjacent ridges, the largest distance between the midpoints of the width of said two adjacent ridges. So in case of a subpit its width contains not only the respective extension of the subpit itself, but also the distance between the edge of a wall delimiting the subpit and the half of the width of this delimiting wall, and/or also the distance between the edge of a ridge delimiting the subpit and the half of the width of this ridge, as the case may be.

Preferably, the width of a subpit is from 10 to 400 μm, more preferably from 20 to 400 μm, even more preferably from 30 to 400 μm, especially from 100 to 400 μm, more especially from 150 to 400 μm, even more especially from 200 to 400 μm, in particular from 225 to 375 μm; typical values are 250 μm, 300 μm and 350 μm.

Preferably, the width of a subpit which is delimited by two adjacent ridges is from 100 to 400 μm, preferably from 150 to 400 μm, more preferably from 200 to 400 μm, even more preferably from 225 to 375 μm; typical values are 250 μm, 300 μm and 350 μm.

Preferably, when the large pit contains only one ridge, then this ridge is centered in the large pit and divides the large pit into two subpits with comparable size, shape and width.

Preferably, when the large pit contains more than one ridge which run parallel to each other and have the same width, then the width of the subpits between any two adjacent ridges, that is the distance of the midpoints of the widths of the two adjacent ridges, are the same.

Preferably, a ridge is or, when the large pit contains more than one ridge, the ridges are distributed evenly over the length of large pit, so that the subpits which are delimited by two adjacent ridges have a comparable size and shape.

In an embodiment, a ridge has the contour of a straight line, is inclined with an angle against the direction of the length of the gravure printing cylinder, preferably, the angle of a ridge is from 15 to 75°, and has the same width over its entire length, and,
when the large pit contains one ridge, then
   the ridge is located centered in the large pit;
when the large pit contains more than one ridges, then
   all ridges have the same contour;
   all ridges have the same angle, so all ridges run parallel to each other, preferably, the angle of a ridge is from 15 to 75°, also with any of the embodiments of their angle as defined herein; and
   all ridges have the same width, preferably of at least 10 μm, also with any of the embodiments of their width as defined herein;
   the width of all subpits which are delimited by two adjacent ridges are the same, preferably from 100 to 400 μm, also with any of the embodiments of their width as defined herein;
   the ridges are distributed evenly over the length of large pit, so that the subpits which are delimited by two adjacent ridges have a comparable size and shape.

In case of two or more ridges in the large pit, the subpits bordering at the two longitudinal ends of the large pit may have a different width than any subpit between two adjacent ridges even if the distance between the midpoints of the widths of any two adjacent ridges is the same, this may be caused by the specific contour of the large pit; for example when the large pit has the contour of a rectangle containing three ridges with the same contour of a straight line and with the same width and running parallel with the angle of 45°, the two subpits delimited by two adjacent ridges have the contour of a hash whereas the contour of the two subpits at the two longitudinal ends of the large pit can be a triangle, and the widths of the hash and of width of the triangles are not necessarily the same.

In gravure printing the ink can be transferred to the engraved gravure printing cylinder directly from an ink reservoir into which the gravure printing cylinder is partly immersed, and from the gravure printing cylinder the ink is transferred directly onto the print substrate, this embodiment is called direct gravure printing

For indirect gravure printing, the engraved gravure printing cylinder transfers ink to a transfer roller, and the transfer roller transfers it to the print substrate.

In both embodiments, as the gravure printing cylinder rotates, it draws excess ink onto its unengraved surface and into the engraved pits. Acting as a squeegee, a doctor blade scrapes the gravure printing cylinder before it makes contact with the print substrate, removing any excess ink from the non-printing, that is from the unengraved areas and leaving in the pits the right amount of ink required. The doctor blade is usually arranged in the direction essentially parallel to the length of the gravure printing cylinder. In case of a pit of ENGRAVING-NORM the size of the pit is such that the doctor blade does not penetrate into the pit in a way that would disturb because the unsupported part of the doctor blade above the pit is not long enough to allow any noticeable penetrating of the doctor blade into the pit, but in case of the large pit of ENGRAVING-TAG the doctor blade should not enter into the large pit and scrape the large pits partially or even completely empty of ink, so the unsupported part of the doctor blade above a large pit should not be too long.

Any ridge serves the purpose of supporting the doctor blade and thereby it is avoided that the doctor blade penetrates into the large pit, at least not to an extent which would have a negative impact on the print quality; thereby it is avoided that a large pit is scraped empty by the doctor blade.

Ideally a ridge abuts the wall of the large pit at the points where the ridge starts and ends, at these points the ridge is usually connected with the wall thereby the ridge continuously merges with the wall. But caused by the specific engraving method a ridge may not completely abut the wall, there may be a small gap, either completely or partly separating the ridge from the wall; these gaps have a maximum width of about 30 μm, preferably of about 20 μm, more preferably of about 10 μm. The depth of these gaps may be the depth of the large pit or less. Such gaps usually occur irregularly, some starting or end points of ridges have them, some not.

In an embodiment,
the width of the wall of ENGRAVING-TAG is from 5 to 25 μm, also with any of the embodiments of its width as defined herein;
ENGRAVING-TAG and the large pit of ENGRAVING-TAG have same contours, a contour of a rectangle;
preferably, the depth of the large pit is from 15 to 40 μm;
preferably, ENGRAVING-TAG extends with its length in the direction of the axis of the gravure printing cylinder;
preferably, the lower limit of the length of ENGRAVING-TAG is 0.4 mm, also with any of the embodiments of its length as defined herein; and
the large pit can contain at least one ridge, a ridge has the contour of a straight line, is inclined with an angle against the direction of the length of the gravure printing cylinder. preferably, the angle of a ridge is from 15 to 75°, and has the same width over its entire length, and,
when the length of the large pit, that is its largest longitudinal extension from one wall to the opposite wall delimiting the large pit, is 500 μm or larger, preferably 550 μm or larger, more preferably 600 μm or larger, then the large pit contains at least one ridge;
when the large pit contains one ridge, then
the ridge is located centered in the large pit;
when the large pit contains more than one ridges, then
all ridges have the same contour;
all ridges have the same angle, so all ridges run parallel to each other, preferably, the angle of a ridge is from 15 to 75°, also with any of the embodiments of their angle as defined herein; and
all ridges have the same width, preferably of at least 10 μm, also with any of the embodiments of their width as defined herein;
the width of all subpits which are delimited by two adjacent ridges are the same, preferably from 100 to 400 μm, also with any of the embodiments of their width as defined herein;
the ridges are distributed evenly over the length of large pit, so that the subpits which are delimited by two adjacent ridges have a comparable size and shape.

The pit of ENGRAVING-NORM has a shape that is common and known for engravings on gravure printing cylinders for gravure printing, so common and known for gravure printing.

The wall of ENGRAVING-NORM surrounding the pit delimits the pit; preferably the wall of ENGRAVING-NORM has the essentially same width in lateral direction over its whole length.

The width and the length of the wall of ENGRAVING-NORM are lateral dimensions, the width is perpendicular to the length and is preferably from 5 to 25 μm, more preferably from 10 to 20 μm, even more preferably from 12.5 to 17.5 μm; a typical value is 15 μm.

The length of the pit of ENGRAVING-NORM is the length in the direction of the largest lateral extension of the pit of ENGRAVING-NORM;
the width of the pit of ENGRAVING-NORM is the largest lateral extension of the pit of ENGRAVING-NORM perpendicular to its length;
the length of the pit of ENGRAVING-NORM is equal to or larger than its width.

The size of the width of the pit of ENGRAVING-NORM is at least 10%, preferably at least (5/30) %; and/or
an upper limit can be 98.75%;
typical values are at least 50%, a typical range is from 50 to 98.75%;
of the size of the width of ENGRAVING-NORM.

ENGRAVING-NORM and the pit of ENGRAVING-NORM can have same, or at least essentially same, or different contours, a contour may be any kind of contour, such as the contour of a square, circle, ellipse, rectangle or line, preferably of a square, of a circle or of a line; preferably, ENGRAVING-NORM and the pit of ENGRAVING-NORM have same contours or at least essentially same contours, preferably of a square, of a circle or of a line;
preferably, when the contour is a line then it is a straight line; and/or
preferably, in case of a plurality of ENGRAVING-NORM in AREA-NORM, each ENGRAVING-NORM has the same contour or at least essentially same contour.

The depth of the pit of ENGRAVING-NORM is preferably at least 15 μm, more preferably at least 17.5 μm.

Preferably, the depth of the pit of ENGRAVING-NORM is from 15 to 40 μm, more preferably from 17.5 to 40 μm, even more preferably from 17.5 to 35, especially from 17.5 to 32.5 μm, typical values are 20 μm, 25 μm and 30 μm.

Preferably, in case of a plurality of ENGRAVING-NORM in AREA-NORM, each ENGRAVING-NORM has the same depth.

Preferably, the pit of ENGRAVING-NORM is a pit with an essentially flat bottom surrounded by a wall. Essentially flat means that the engraving method aims at providing a flat bottom of the pit, but there may be small deviations in the flatness of the bottom caused by the specific engraving technique. For example the transition from the wall to the bottom of the pit can be a sharp and well defined 90° kink but it can also have a curved contour. The other areas of the bottom may have said small deviations in depth, these deviations are preferably up to 20%, more preferably up to 10%, even more preferably up to 7.5%, especially up to 5%, of the depth of the pit of ENGRAVING-NORM, with the values stated herein of the depth of ENGRAVING-NORM being an average depth of the area of the bottom of the pit. For example when the width of the pit becomes smaller, the contour of a vertical crosscut through an ENGRAVING in the direction of its width can have the contour of a U.

The wall of ENGRAVING-NORM surrounding the pit delimits the pit and the wraparound edge of the wall of the pit can be called the rim of the wall of the pit or simply the rim of the pit herein for ease of reading. In case that AREA-NORM contains a plurality of ENGRAVING-NORMs, preferably the distance between any two adjacent ENGRAVING-NORMs in AREA-NORM is the same;
more preferably, any two adjacent ENGRAVING-NORMs in AREA-NORM abut each other;
in case of abutting a distance between the adjacent rims of the pits of two adjacent ENGRAVING-NORMs is preferably from 10 to 50 μm, more preferably from 20 to 40 μm, even more preferably from 25 to 35 μm; a typical value is 30 μm.

In an embodiment,
the wall of ENGRAVING-NORM has the essentially same width over its whole length, preferably the width of the wall of ENGRAVING-NORM is from 5 to 25 μm, also with any of the embodiments of its width as defined herein;
ENGRAVING-NORM and the pit of ENGRAVING-NORM have the essentially same contours, preferably the contour of a square or of a straight line;
the depth of the pit of ENGRAVING-NORM is at least 15 μm, also with any of the embodiments of its depth as defined herein; and
in case of a plurality of ENGRAVING-NORM in AREA-NORM, all ENGRAVING-NORMs have the same width of its wall, contour and depth, and any two adjacent ENGRAVING-NORMs in AREA-NORM abut each other, preferably with a distance between the adjacent rims of the pits of two adjacent ENGRAVING-NORMs of from 10 to 50 μm, also with any of the embodiments of the distance as defined herein.

The ENGRAVING-NORMs can be distributed over AREA-NORM randomly, or they can be distributed over AREA-NORM in any order and pattern.

For an individual ENGRAVING-NORM an angle, ANG-1, can be defined for the case that ENGRAVING-NORM and the pit of ENGRAVING-NORM have same, or at least essentially same, contours and ENGRAVING-NORM has
a length that is larger than its width, and/or
if at least a part of the contour of ENGRAVING-NORM has the contour of a straight line, then
the direction of said length or said the direction of said part of the border with the contour of a straight line has ANG-1 against the direction of the length of the gravure printing cylinder of from 0 to 90°, preferably of from 10 to 80°, more preferably of from 15 to 75°, even more preferably of from 25 to 65°, especially of from 35 to 55°; a typical value of ANG-1 is 45°.

So in case that ENGRAVING-NORM is for example
a square then one border of the square has ANG-1; or
a rectangle then the length of the rectangle has ANG-1; or
an ellipse then the direction of the longer extension of the ellipse has ANG-1; or
a straight line then the line has ANG-1.

Preferably, in case of a plurality of ENGRAVING-NORM in AREA-NORM, each ENGRAVING-NORM has the same ANG-1.

A second angle, ANG-2, of ENGRAVING-NORM can be defined for the case that at least a number of the ENGRAVING-NORMs form a straight line of succession, this preferably for the case of ENGRAVING-NORM having the contour of a square, a circle or a rectangle with a ratio of length to width of from more than 1 to 2.5, preferably of a square, then the direction of said straight line of succession has preferably an angle, ANG-2, against the direction of the length of the gravure printing cylinder of from 0 to 90°, typical values of ANG-2 are 0°, 45° and 90°.

Preferably, the distance between any two successive ENGRAVING-NORMs in the straight line of succession is always the same, more preferably they abut each other.

In case that AREA-NORM contains a plurality of such straight lines of succession, then preferably all the straight lines of succession have the same ANG-2;

more preferably, all the straight lines of succession have the same ANG-2 and all the straight lines of succession are consecutively adjacent and parallel to each other, and preferably the distance between any two successive straight line of succession adjacent to each other is the same, more preferably the ENGRAVING-NORMs in any two adjacent straight lines of succession abut each other so an two adjacent straight lines of succession can be viewed as abutting each other, the term “ENGRAVING-NORMs in adjacent straight lines of succession abut each other” or “adjacent straight lines of succession abut each other” used herein means that the ENGRAVING-NORMs in one straight line of succession abut with the ENGRAVING-NORMs in the adjacent straight line of succession;
in case of abutting a distance between the adjacent rims of the walls of the adjacent pits of two adjacent ENGRAVING-NORMs, each located in a different of two adjacent straight lines of succession, is preferably from 10 to 50 μm, more preferably from 20 to 40 μm, even more preferably from 25 to 35 μm; a typical value is 30 μm.

In case of ENGRAVING-NORM having the contour of a square, a circle or a rectangle with a ratio of length to width of from more than 1 to 2.5, preferably of a square, AREA-NORM contains two or more straight lines of succession of ENGRAVING-NORMs and all ENGRAVING-NORMs are contained in said straight lines of succession.

A third angle, ANG-3, of ENGRAVING-NORM can be defined for the case that
a number of the ENGRAVING-NORMs form at least two straight lines of succession being parallel and adjacent to each other, preferably abut each other, and
the distance between any two successive ENGRAVING-NORMs in each of these adjacent straight lines of succession is the same; preferably, any two successive ENGRAVING-NORMs in each of these adjacent straight lines of succession abut each other,

ANG-3 defines a possible offset of these two straight lines of succession against each other, wherein an imaginary straight line, that is connecting the center points of the contour of a first ENGRAVING-NORM in one of two straight lines of succession adjacent to each other with the center point of the contour of a second ENGRAVING-NORM adjacent to the first ENGRAVING-NORM but located in the other straight line of succession, has preferably ANG-3 against the direction of the straight lines of succession of from 45 to 135°, typical values of ANG-3 are 45° and 90°, preferably 90°. So the position of the ENGRAVING-NORMs in these two adjacent straight lines of succession can be offset against each other and the offset is defined by ANG-3. ANG-3 of 90° means no offset.
In case that AREA-NORM contains a plurality of such straight lines of succession consecutively adjacent to each other, then preferably any two adjacent straight lines of succession have the same ANG-3 against each other; and, preferably, all the straight lines of succession are consecutively adjacent and parallel to each other, and preferably the distance between any two successive straight lines of succession adjacent to each other is the same, more preferably any two adjacent straight lines of succession abut each other;
in case that AREA-NORM contains a plurality of ENGRAVING-NORMs having the same contour of a line then preferably all these lines are straight lines and are consecutively adjacent to and parallel to each other and any two adjacent straight lines have the same ANG-3 of from 45 to 135°, typical values of ANG-3 are 45° and 90°, preferably 45° against each other, and preferably the distance between any two of these successive lines adjacent to each other is the same, more preferably any two adjacent ENGRAVING-NORMs having the same contour of a straight line abut each other;
in case of abutting a distance between the adjacent rims of the walls of the adjacent pits of two adjacent ENGRAVING-NORMs, each located in a different of two adjacent straight lines of succession or in a different ENGRAVING-NORM with the contour of a straight line, is preferably from 10 to 50 μm, more preferably from 20 to 40 μm, even more preferably from 25 to 35 μm; a typical value is 30 μm.

The number of ENGRAVING-NORMs in such a straight line of succession is preferably from 50 to 150, more preferably 70 to 130, even more preferably 90 to 130, of ENGRAVING-NORM per cm; a typical value is 120 of ENGRAVING-NORM per cm; these values are preferably the case when the ENGRAVING-NORM have the contour of a square or circle.

In case that the contour of ENGRAVING-NORM is an ellipse, rectangle or line, the distance between the midpoints of the width of two adjacent ENGRAVING-NORM in the direction perpendicular to the direction of the longest extension of ENGRAVING-NORM is preferably from 50 to 150, more preferably 70 to 130, even more preferably 90 to 130 per cm.

The width of ENGRAVING-NORM is less than 0.4 mm. ENGRAVING-NORM has preferably a width of from 30 to less than 400 μm, more preferably of from 30 to 300 μm, even more preferably of from 30 to 200 μm, especially of from 60 to 160 μm, more especially of from 70 to 150 μm, even more especially of from 75 to 145 μm, typical values are from 80 to 90 μm, such as 83 μm, or from 140 to 150 μm, such as 143 μm; in particular 83 μm; and/or in case of a plurality of ENGRAVING-NORM in AREA-NORM, each ENGRAVING-NORM has the same width.

The length of ENGRAVING-NORM is limited by the dimensions of AREA-NORM.

Preferably, the lower limit of the length of ENGRAVING-NORM is equal to the lower limit of the width of ENGRAVING-NORM; so a lower limit of the length of ENGRAVING-TAG is preferably 30 μm, more preferably 60 μm, even more preferably 70 μm, especially 80 μm.

Preferably, in case of a plurality of ENGRAVING-NORM in AREA-NORM, each ENGRAVING-NORM has the same length.

ENGRAVING-NORM and ENGRAVING-TAG can have same or different depths.

In an embodiment,
the wall of ENGRAVING-NORM has the essentially same width over its whole length, preferably the width of the wall of ENGRAVING-NORM is from 5 to 25 μm, also with any of the embodiments of its width as defined herein;
ENGRAVING-NORM and the pit of ENGRAVING-NORM have the essentially same contours, preferably a contour of a square or of a straight line;
one border of the square or the straight line, respectively, has an angle, ANG-1, against the direction of the length of the gravure printing cylinder of from 0 to 90°, also with any of the embodiments of ANG-1 as defined herein;
the depth of the pit of ENGRAVING-NORM is at least 15 μm, also with any of the embodiments of its depth as defined herein; and
AREA-NORM contains and is completely filled with a plurality of ENGRAVING-NORMs with any two adjacent ENGRAVING-NORMs abutting each other, every ENGRAVING-NORM has the same width of its wall, contour, ANG-1, length, depth and width, preferably, the width is from 30 to less than 400 μm, also with any of the embodiments of the width as defined herein;
in case of ENGRAVING-NORM having the contour of a square AREA-NORM contains two or more straight lines of succession of ENGRAVING-NORMs and all ENGRAVING-NORMs are part of said straight lines of succession and the direction of any straight line of succession has the same angle, ANG-2, against the direction of the length of the gravure printing cylinder of from 0 to 90°, preferably 45°, also with any of the embodiments of ANG-2 as defined herein; all the straight lines of succession are consecutively adjacent and parallel to each other and any two adjacent straight lines of succession abut each other, preferably the distance between the adjacent rims of the walls of the adjacent pits of two adjacent ENGRAVING-NORMs, each located in a different of two adjacent straight lines of succession, is from 10 to 50 μm, also with any of the embodiments of the distance as defined herein;
a possible offset between any two adjacent straight lines of succession against each other is defined by ANG-3, wherein an imaginary straight line, that is connecting the center points of the contour of a first ENGRAVING-NORM in one of two straight lines of succession adjacent to each other with the center point of the contour of a second ENGRAVING-NORM adjacent to the first ENGRAVING-NORM but located in the other straight line of succession, has ANG-3 against the direction of the straight lines of succession of from 45 to 135°, preferably 90°, also with any of the embodiments of ANG-3 as defined herein;
in case of ENGRAVING-NORM having the contour of a straight line all the straight lines are consecutively abutting and parallel to each other and a possible offset between any two adjacent straight lines against each other is defined by ANG-3, wherein an imaginary straight line, that is connecting the center points of the contour of a first ENGRAVING-NORM with the center point of the contour of a second ENGRAVING-NORM abutting the first ENGRAVING-NORM, has ANG-3 against the direction of the straight lines of from 45 to 135°, any two abutting straight lines have the same ANG-3 of from 45 to 135°, preferably 45°, against each other, also with any of the embodiments of ANG-3 as defined herein, preferably the distance between the adjacent rims of the walls of the adjacent pits of two abutting ENGRAVING-NORMs is from 10 to 50 μm, also with any of the embodiments of ANG-3 as defined herein.

In an embodiment,
the engraved pattern comprises an AREA-NORM and one only AREA-TAG;
AREA-NORM contains and is completely filled with a plurality of ENGRAVING-NORMs with any two adjacent ENGRAVING-NORMs abutting each other,
AREA-TAG contains only one ENGRAVING-TAG,
at least all the part of the border of AREA-TAG on the side of AREA-TAG that is opposite to the printing direction abuts at least part of the AREA-NORM; that means that AREA-NORM in this embodiment fully covers any border of AREA-TAG on the side of AREA-TAG that is opposite to the printing direction, preferably, AREA-TAG is completely enclosed by AREA-NORM abutting AREA-TAG.

In an embodiment,
AREA-TAG has only one ENGRAVING-TAG and the area of ENGRAVING-TAG and AREA-TAG are identical;
AREA-NORM is completely filled with a plurality of ENGRAVING-NORMs with any two adjacent ENGRAVING-NORMs abutting each other;
the border of AREA-NORM is constituted by a succession of ENGRAVING-NORMs abutting each other;
AREA-NORM abuts and completely covers any part of the border of AREA-TAG on the side of AREA-TAG that is opposite to the printing direction; preferably, AREA-NORM fully encloses and abuts AREA-TAG;
the width of those parts of AREA-NORM, which are abutting AREA-TAG, is preferably at least 0.1 mm, also with any of the embodiments of this width as described herein;
the width of the wall of ENGRAVING-TAG is from 5 to 25 μm, also with any of the embodiments of its width as defined herein;
ENGRAVING-TAG and the large pit of ENGRAVING-TAG have same contours, a contour of a rectangle;
preferably, the depth of the large pit is from 15 to 40 μm;
preferably, ENGRAVING-TAG extends with its length in the direction of the axis of the gravure printing cylinder;
preferably, the lower limit of the length of ENGRAVING-TAG is 0.4 mm, also with any of the embodiments of its length as defined herein;
when the length of the large pit, that is its largest longitudinal extension from one wall to the opposite wall delimiting the large pit, is 500 μm or larger, preferably 550 μm or larger, more preferably 600 μm or larger, then the large pit contains at least one ridge, a ridge has the contour of a straight line, is inclined with an angle against the direction of the length of the gravure printing cylinder and has the same width over its entire length;
when the large pit contains one ridge, then
the ridge is located centered in the large pit;
when the large pit contains more than one ridges, then
all ridges have the same contour;
all ridges have the same angle, so all ridges run parallel to each other, preferably, the angle of a ridge is from 15 to 75°, also with any of the embodiments of their angle as defined herein; and
all ridges have the same width, preferably of at least 10 μm, also with any of the embodiments of their width as defined herein;
the width of all subpits which are delimited by two adjacent ridges are the same, preferably from 100 to 400 μm, also with any of the embodiments of their width as defined herein;
the ridges are distributed evenly over the length of large pit, so that the subpits which are delimited by two adjacent ridges have a comparable size and shape;
the wall of ENGRAVING-NORM has the essentially same width over its whole length, preferably the width of the wall of ENGRAVING-NORM is from 5 to 25 μm, also with any of the embodiments of its width as defined herein;
ENGRAVING-NORM and the pit of ENGRAVING-NORM have the essentially same contours, a contour of a square or of a straight line;
one border of the square and the straight line, respectively, have an angle, ANG-1, against the direction of the length of the gravure printing cylinder of from 0 to 90°, also with any of the embodiments of ANG-1 as defined herein;
the depth of the pit of ENGRAVING-NORM is at least 15 μm, also with any of the embodiments of its depth as defined herein; and
AREA-NORM contains and is completely filled with a plurality of ENGRAVING-NORMs with any two adjacent ENGRAVING-NORMs abutting each other, every ENGRAVING-NORM has the same width of its wall, contour, ANG-1, length, depth and width, preferably, the width is from 30 to less than 400 μm, also with any of the embodiments of the width as defined herein;
in case of ENGRAVING-NORM having the contour of a square AREA-NORM contains two or more straight lines of succession of ENGRAVING-NORMs and all ENGRAVING-NORMs are part of said straight lines of succession and the direction of any straight line of succession has the same angle, ANG-2, against the direction of the length of the gravure printing cylinder of from 0 to 90°, also with any of the embodiments of ANG-2 as defined herein;
all the straight lines of succession are consecutively adjacent and parallel to each other and any two adjacent straight lines of succession abut each other, preferably the distance between the adjacent rims of the walls of the adjacent pits of two adjacent ENGRAVING-NORMs, each located in a different of two adjacent straight lines of succession, is from 10 to 50 μm, also with any of the embodiments of the distance as defined herein;
a possible offset between any two adjacent straight lines of succession against each other is defined by ANG-3, wherein an imaginary straight line, that is connecting the center points of the contour of a first ENGRAVING-NORM in one of two straight lines of succession adjacent to each other with the center point of the contour of a second ENGRAVING-NORM adjacent to the first ENGRAVING-NORM but located in the other straight line of succession, has ANG-3 against the direction of the straight lines of succession of from 45 to 135°, preferably, 90°, also with any of the embodiments of ANG-3 as defined herein;
in case of ENGRAVING-NORM having the contour of a straight line all the straight lines are consecutively abutting and parallel to each other and a possible offset between any two adjacent straight lines against each other is defined by ANG-3, wherein an imaginary straight line, that is connecting the center points of the contour of a first ENGRAVING-NORM with the center point of the contour of a second ENGRAVING-NORM abutting the first ENGRAVING-NORM, has ANG-3 against the direction of the straight lines of from 45 to 135°, any two abutting straight lines have the same ANG-3 of from 45 to 135°, preferably 45°, against each other, also with any of the embodiments of ANG-3 as defined herein, preferably the distance between the adjacent rims of the walls of the adjacent pits of two abutting ENGRAVING-NORMs is from 10 to 50 μm, also with any of the embodiments of ANG-3 as defined herein.

The term “essentially the same” with respect.
to any of the contours of ENGRAVING-TAG, of the large pit of ENGRAVING-TAG, of ENGRAVING-NORM, and of the pit of ENGRAVING-NORM,
to the width of the wall surrounding the large pit of ENGRAVING-TAG, and
to the width of the wall surrounding the pit of ENGRAVING-NORM,
means that depending on the engraving process with which the large pit and the pit, respectively, is engraved into the surface of the gravure printing cylinder, there may be in lateral direction small variations or fluctuations caused by the specific engraving process and engraving technique between said contours and widths. Such variations or fluctuations may have the size of up to 100% or up to 75% of the width of the wall of ENGRAVING-TAG, of the width of the wall of ENGRAVING-NORM, of the width of the wall surrounding the large pit of ENGRAVING-TAG, and of the width of the wall surrounding the pit of ENGRAVING-NORM, respectively.
For engraving the pattern into the surface of the gravure printing cylinder any known engraving technique can be used, such as mechanical, chemical or optical engraving.
A further subject of the invention is a method for engraving a pattern for printing with large-sized tags containing AREA-NORM with ENGRAVING-NORM and AREA-TAG with ENGRAVING-TAG into the surface of the gravure printing cylinder, wherein
the pit of ENGRAVING-NORM and the large pit of ENGRAVING-TAG are engraved into the surface of the gravure printing cylinder;
the engraving is done by mechanical, chemical or optical engraving;
with AREA-NORM, ENGRAVING-NORM, AREA-TAG, ENGRAVING-TAG and the gravure printing cylinder as defined herein, also with all their embodiments.

Mechanical engraving can be done with a diamond tool.

Chemical engraving can be done by chemical etching.

Optical engraving is also called photoengraving and is preferably laser engraving.

Preferably, the engraving is done by optical engraving, more preferably, by laser engraving.
Further subject of the invention is a method for gravure printing a pattern containing large-sized tags onto the surface of a print substrate, wherein
the gravure printing is done with the gravure printing cylinder as described herein, also with all its embodiments, and
employing a gravure printing ink containing large-sized tags;
preferably, the print substrate is a two-piece hard capsule shell or a body or a cap of a two-piece hard capsule shell;
preferably the sizes of the large-sized tags are from 20 to 150 μm;
preferably the large-sized tags are chemically silicon dioxide;
with the gravure printing cylinder, the print substrate and the large-sized tags as defined herein, also with all their embodiments.

The gravure printing ink can be an aqueous gravure printing ink or a solvent based gravure printing ink, preferably a solvent based gravure printing ink.

The large-sized tags are known to the skilled person:
EP 2513654 B1 discloses
   in [0064] in connection with [0046] a tag with a physical thickness L of 15 μm,
so a possible value for the thickness of a large-sized tag is 15 μm.
EP 2513654 B1 discloses
   in [0012] that films can be broken into small tags ranging from hundreds of nanometers to hundreds of micrometers of more in size, and
   discloses that at sizes as small as 20 microns across, the tags are inconspicuous enough to avoid casual inspection.
WO 2011/159338 A1 discloses in
   that a inconspicuous size range from 20 to 150 μm allows covert or semi-covert use of the tags.
On the internet page of TruTag Technologies, Inc., Honolulu, 96826 USA, a size range for tags of from 50 to 100 μm is disclosed.

So according to the present invention, preferably the sizes of large-sized tags are in these size ranges, more preferably from 20 to 150 μm or from 50 to 100 μm.

With the dimensions of the width of ENGRAVING-NORM being less than 0.4 mm and of the lower limit of the width of ENGRAVING-TAG being 0.4 mm, the gravure printing cylinder is, in particular ENGRAVING-NORM and ENGRAVING-TAG are, adapted for gravure printing of said large-sized tags.

In particular, the dimensions of the width of ENGRAVING-TAG are adapted to receive said large-sized tags contained in a gravure printing ink. The width of ENGRAVING-NORM is not adapted for receiving said large-sized tags. By these means said large-sized tags are preferentially received by ENGRAVING-TAG; a high percentage of large-sized tags is transferred by the gravure printing cylinder, that is by the ENGRAVING-TAG, onto the print substrate.

EP 2513654 B1 disclose processes for preparing tags as summarized in the following:
[0008]: The identifier comprises a rugate phase tag.
[0007]: The rugate phase tag comprises oxidized etched silicon.
[0012]: The films can be broken into small pieces, or tags . . . oxidizing these films, thus forming optically clear silicon dioxide, also known as silica. A porous silica film, aka “optical film”, can be diced, or otherwise fragmented, to create “optical microtags”, or simply “tags”. In various embodiments, the silicon film is fragmented, then oxidized into silica, oxidized and then fragmented, or any other appropriate sequence of steps to produce a rugate microtag.
[0014]: Silicon wafers are processed into thin, porous, silicon films with a controllable density of embedded pores (“rug ate films”). This process allows the control of the optical properties of silicon films, which carry over into the optical properties of the silica films obtained through oxidation. Silica films produced using this technique can be made into small tags (i.e., rugate microtags) that carry information encoded in the form of their particular optical spectrum. In some embodiments, silicon is etched and then fragmented and then oxidized.
[0015]: The porous silicon film was made by acid-etching a silicon wafer in the presence of an electric current. The etching process creates small pores or cavities in the wafer, the dimensions of which are controlled by the current density of the etching current waveform. The dimensions that are controlled include the depth of pores etched in the silicon film and the diameter and density of the pores; size and density modulation is achieved by controlling electric current density with time.
[0072]:
   . . .
      acid-etching a silicon wafer using the waveform to create region of porous silicon in the silicon wafer;
      lifting a film of porous silicon from the wafer using an electropolishing reaction;
      breaking or cutting porous silicon film into rugate microtags;
      oxidizing the porous silicon film to create a porous silica film;
      applying rugate microtags to objects or embedding rugate microtags in objects.
   . . .
WO 2011/159338 A1 disclose
   [0021]: Tags comprise a silicon wafer that is etched to have a spectral code encoded by the etching. The wafer is divided into small tags, and the resultant tags contain a complex porous nanostructure that is programmed during electrochemical synthesis to display a unique reflectivity spectrum. The tags are then oxidized by a high-temperature bake step to turn the crystalline, nanoporous silicon tags into amorphous, nanoporous silica. This bake step stabilizes the nanoporous structure against further oxidation (thus stabilizing the spectral signature) . . . .

So preferably the large-sized tags are oxidized etched silicon which chemically is silicon dioxide, also known as silica.
Further subject of the invention is a gravure printed pattern containing large-sized tags;
preferably, the gravure printed pattern containing large-sized tags is obtainable by gravure printing with the gravure printing cylinder as defined herein, also with all its preferred embodiments;
preferably, the gravure printed pattern containing large-sized tags is obtainable by gravure printing a gravure printed pattern onto the surface of a print substrate with the method for gravure printing a pattern containing large-sized tags as defined herein, also with all the preferred embodiments of the method;
preferably the sizes of the large-sized tags are from 20 to 150 μm;
preferably the large-sized tags are chemically silicon dioxide;
with the large-sized tags as defined herein, also with all their embodiments.
Further subject of the invention is a print substrate with a gravure printed pattern containing large-sized tags gravure printed on its surface;
preferably, the gravure printed pattern containing large-sized tags is obtainable by gravure printing with the gravure printing cylinder as defined herein, also with all its preferred embodiments;
preferably, the gravure printed pattern containing large-sized tags is obtainable by gravure printing a gravure printed pattern onto the surface of the print substrate with the method for gravure printing a pattern containing large-sized tags as defined herein, also with all its preferred embodiments of the method;
preferably, the print substrate is the print substrate is a two-piece hard capsule shell or a body or a cap of a two-piece hard capsule shell;
preferably the sizes of the large-sized tags are from 20 to 150 μm;
preferably the large-sized tags are chemically silicon dioxide;
with the large-sized tags as defined herein, also with all their embodiments.

### BRIEF DESCRIPTION OF THE DRAWINGS

The present invention will be described again with reference to the enclosed drawings, wherein:

FIG. 1 shows the enlarged rectangular section “SECTION RECT” marked in FIG. 2. The bottom of the pits (1-1-1) is denoted with vertical hatching; the bottom of the subpits (2-1-1) with diagonal hatching.

FIG. 2 shows a pattern (9) for printing with large-sized tags engraved into the surface of a gravure printing cylinder with the contour of a T; marked is the rectangular section “SECTION RECT” which is shown enlarged in FIG. 1. The bottom of the pits (1-1-1) is denoted with vertical hatching; the bottom of the subpits (2-1-1) with diagonal hatching.

FIG. 3 shows another pattern (9) for printing with large-sized tags engraved into the surface of a gravure printing cylinder with a contour similar to a crosshair. The bottom of the pits (1-1-1) is denoted with vertical hatching; the bottom of the subpits (2-1-1) with diagonal hatching.

FIG. 4 shows a gravure printed pattern (10) on a print substrate with the contour of a T that was gravure printed with the engraved pattern (9) similar in contour to the one shown in FIG. 2; the large-sized tags (6) are shown as small contours.

FIG. 5 shows the top view of a closed two-piece hard capsule shell (7) with two patterns (10) containing large-sized tags (6) gravure printed on its surface, one was gravure printed with the engraved pattern (9) similar in contour to the one shown in FIG. 2, the other was gravure printed with the engraved pattern (9) similar in contour to the one shown in FIG. 3.

FIG. 6 illustrates the definition
of the printing direction (12-1) of the print substrate (12);
of the printing direction (12-2) of the gravure printing cylinder (11);
side (2-1-5) of AREA-TAG in the printing direction;
side (2-1-6) of AREA-TAG opposite to the printing direction.

### DETAILED DESCRIPTION OF THE PREFERRED EMBODIMENTS

The present invention will now be described in more detail with reference to the enclosed Figures. Same components and arrangements are denoted in the figures by the same reference numerals and the respective description may be omitted in order to avoid redundancies. The drawings are not true to scale.

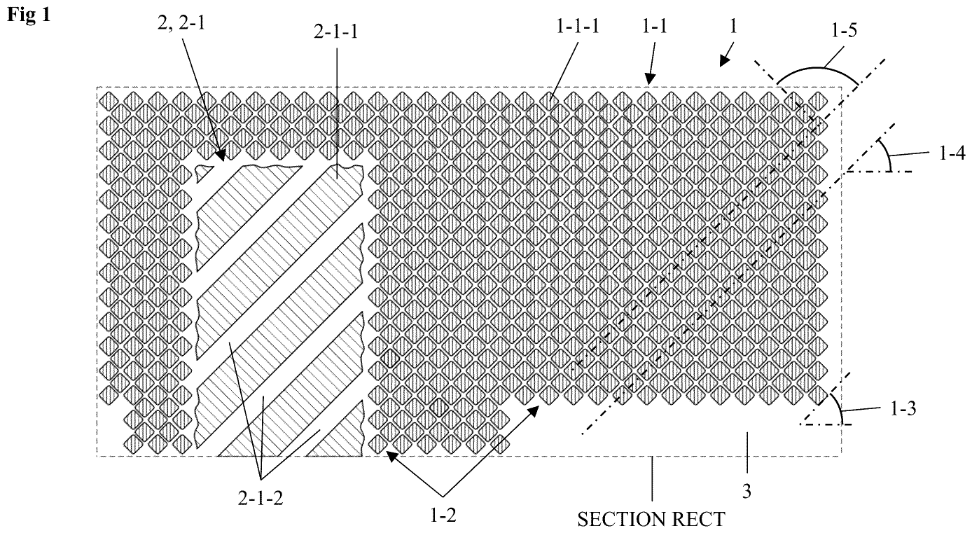

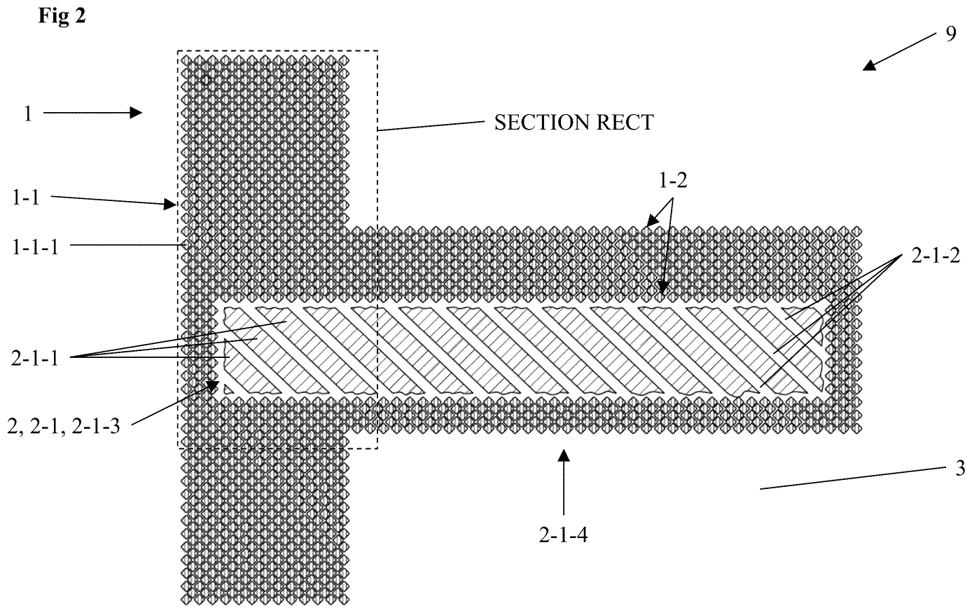

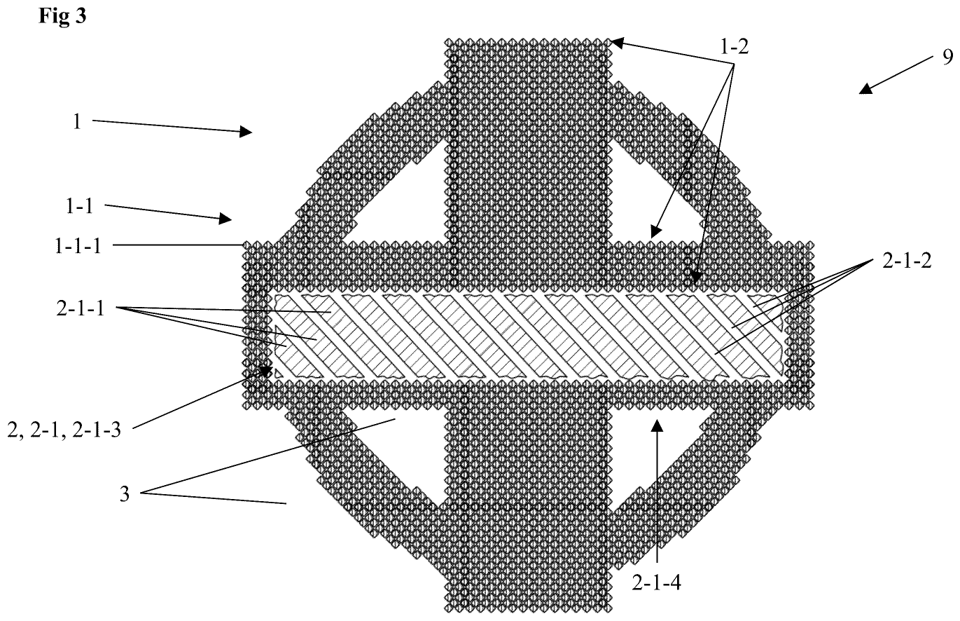

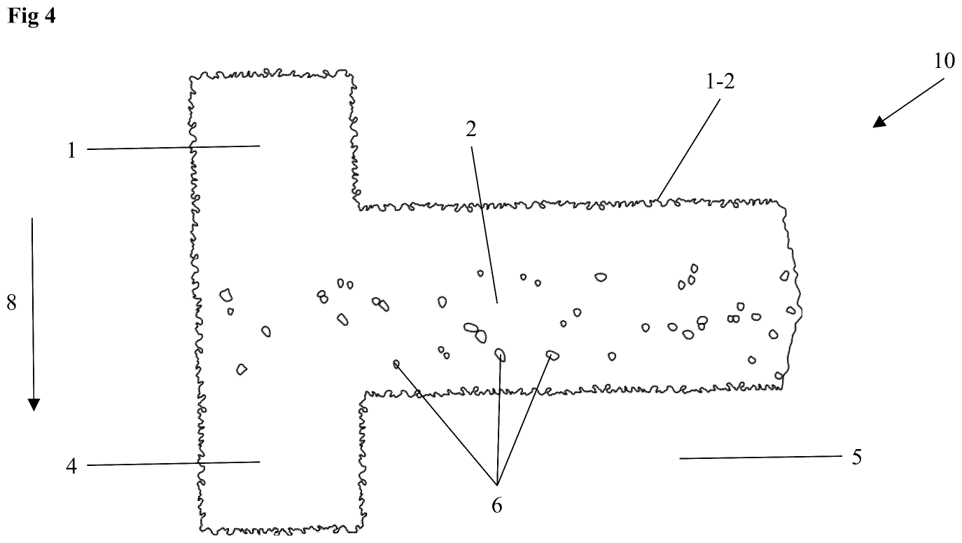

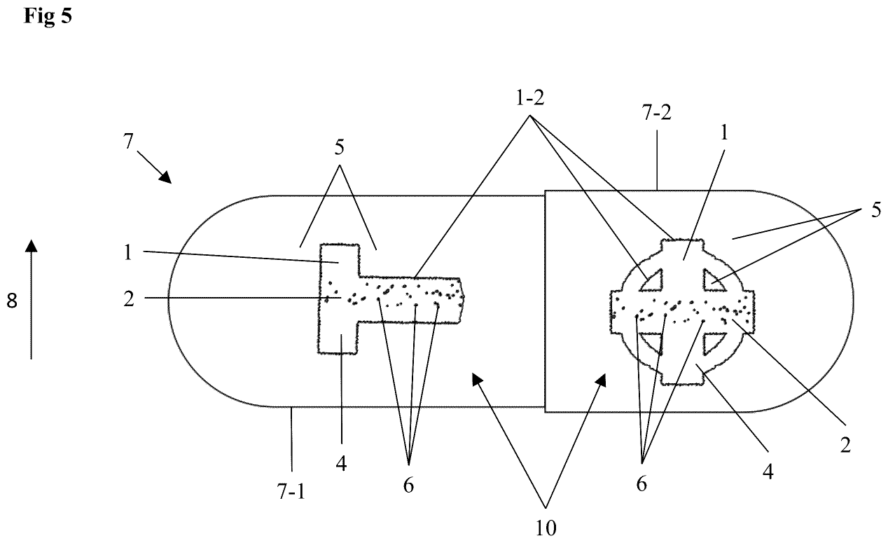

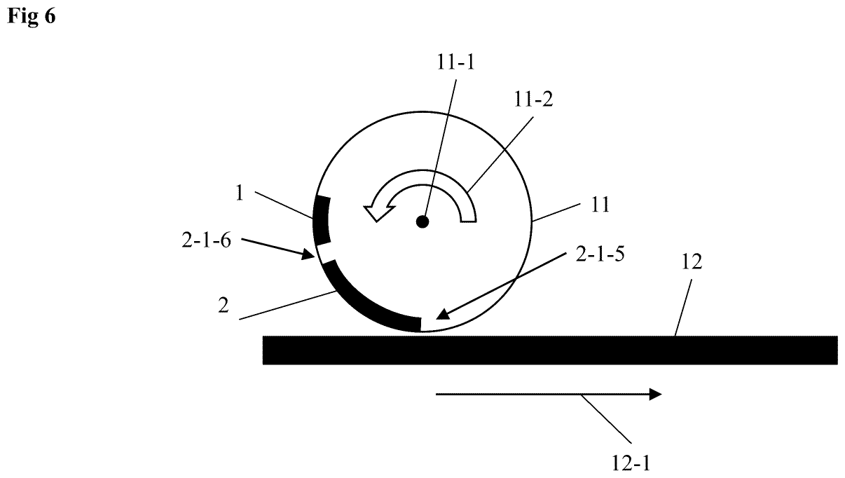

FIG. 1, FIG. 2 and FIG. 3 are enlargements and schematic presentations of actually engraved patterns (9) for printing with large-sized tags, which are not to scale but they are meant to illustrate relative dimensions. FIGS. 4 and 5 are enlargements and schematic presentations of actually printed patterns (10).

FIG. 2 shows an engraved pattern (9) for printing with large-sized tags containing AREA-NORM (1) with ENGRAVING-NORM (1-1) and AREA-TAG (2) with ENGRAVING-TAG (2-1), with the pit of ENGRAVING-NORM (1-1) and the large pit of ENGRAVING-TAG (2-1) engraved into the surface of the gravure printing cylinder in the contour of a T, wherein the pit (1-1-1) of ENGRAVING-NORM (1-1) and the large pit (2-1-3) of ENGRAVING-TAG (2-1) are engraved into the surface of the gravure printing cylinder; the unengraved surface (3) is white without further marking and surrounds the engraved pattern (9); also the top of the walls of ENGRAVING-NORM (1-1) and of ENGRAVING-TAG (2-1) and the top of the ridges (2-1-2) are unengraved surface (3) and are white without further marking. Marked is the rectangular section “SECTION RECT” which is shown enlarged in FIG. 1. The bottom of the pits (1-1-1) of ENGRAVING-NORMs (1-1) is denoted with vertical hatching; the bottom of the subpits (2-1-1) with diagonal hatching.

FIG. 1 shows the enlarged rectangular section “SECTION RECT” marked in FIG. 2. The bottom of the pits (1-1-1) of ENGRAVING-NORMs (1-1) is denoted with vertical hatching; the bottom of the subpits (2-1-1) with diagonal hatching. Also shown in FIG. 1 is ANG-1 (1-3) between one side of an ENGAVING-NORM (1-1), this side has a contour of a straight line and ENGAVING-NORM (1-1) has the contour of a square, and the length of the gravure printing cylinder in case that said length has in FIG. 1 a direction perpendicular to the direction of the length of ENGRAVING-TAG (2-1). FIG. 1 also shows ANG-2 (1-4), the angle between a straight line of succession of ENGRAVING.NORMs (1-1) and the length of the gravure printing cylinder in case that said length has in FIG. 1 a direction perpendicular to the direction of the length of ENGRAVING-TAG (2-1); the ENGRAVING-NORMs (1-1) in the straight line of succession have the contours of a square; the straight line of succession of overlaid by a dotdashed line for illustrating ANG-2 (1-4). Also shown in FIG. 1 is ANG-3 (1-5), which defines a possible offset of two adjacent straight lines of succession against each other, wherein an imaginary straight line, that is connecting the center points of the contour of a first ENGRAVING-NORM (1-1) in one of two straight lines of succession adjacent to each other with the center point of the contour of a second ENGRAVING-NORM (1-1) adjacent to the first ENGRAVING-NORM but located in the other straight line of succession, this imaginary line is illustrated with an elongated dotdashed line in FIG. 1, has ANG-3 (1-5) against the direction of the straight lines of succession; ANG-3 (1-5) is 90° in FIG. 1, so there is no offset between these two straight lines of succession. All the dotdashed lines and the accompanying curved lines indicating the respective angle are only displayed in FIG. 1 in order to illustrate ANG-1 (1-3), ANG-2 (1-4) and ANG-3 (1-5) and are not part of the engraved pattern (9) shown in FIG. 1.

FIG. 3 shows another engraved pattern (9) for printing with large-sized tags with a contour similar to a crosshair containing AREA-NORM (1) with ENGRAVING-NORM (1-1) and AREA-TAG (2) with ENGRAVING-TAG (2-1), with the pit of ENGRAVING-NORM (1-1) and large pit of ENGRAVING-TAG (2-1) engraved into the surface of a gravure printing cylinder, wherein the pit (1-1-1) of ENGRAVING-NORM (1-1) and the large pit (2-1-3) of ENGRAVING-TAG (2-1) are engraved into the surface of the gravure printing cylinder; the unengraved surface (3) is white without further marking, also the top of the walls of ENGRAVING-NORM (1-1) and of ENGRAVING-TAG (2-1) and the top of the ridges (2-1-2) are unengraved surface (3) and are white without further marking. The bottom of the pits (1-1-1) of ENGRAVING-NORMs (1-1) is denoted with vertical hatching; the bottom of the subpits (2-1-1) with diagonal hatching.

FIG. 4 shows a gravure printed pattern (10) on a print substrate with the contour of a T that was gravure printed with the engraved pattern (9) similar in contour to the one shown in FIG. 2. The imprinted area (4) of the gravure printed pattern (10) containing large-sized tags on the print substrate is surrounded by the border (1-2) of AREA-NORM (1) delimiting the printed area from the non-imprinted area (5) of the surface of the print substrate. The non-imprinted area (5) of the surface of the print substrate is white without further marking and surrounds of the gravure printed pattern (10). (1) shows the imprint done by AREA-NORM (1) and (2) shows the imprint done by AREA-TAG (2). The large-sized tags (6) in the imprinted area (2) are shown as small contours. The printing direction of the print surface (8) is marked; ENGRAVING-TAG (2-1) extended with its length in the direction of the axis of the gravure printing cylinder which is apparent by the direction of the longest extension of the area in which large-sized tags (6) have been printed.

FIG. 5 shows the top view of a closed two-piece hard capsule shell (7) with two gravure printed patterns (10) containing large-sized tags gravure printed on its surface, one was gravure printed with the engraved pattern (9) similar in contour to the one shown in FIG. 2, the other was gravure printed with the engraved pattern (9) similar in contour to the one shown in FIG. 3. The printing direction (8) is marked; ENGRAVING-TAG (2-1) extended with its length in the direction of the axis of the gravure printing cylinder which is apparent by the direction of the longest extension of the area in which large-sized tags (6) have been printed.

FIG. 6 illustrates the definition
of the printing direction (12-1) of the print substrate (12);
of the printing direction (11-2) of the gravure printing cylinder (11) when revolving around its axis (11-1) during printing;
side (2-1-5) of AREA-TAG in the printing direction;
side (2-1-6) of AREA-TAG opposite to the printing direction;

In FIG. 2 and FIG. 3,
AREA-TAG (2) has only one ENGRAVING-TAG (2-1), so the area of ENGRAVING-TAG (2-1) and AREA-TAG (2) are identical;
AREA-NORM (1) is completely filled with a plurality of ENGRAVING-NORMs (1-1) with any two adjacent ENGRAVING-NORMs (1-1) abutting each other;
the border (1-2) of AREA-NORM (1) is constituted by a succession of ENGRAVING-NORMs (1-1) abutting each other;
AREA-NORM (1) abuts and completely covers any part of the border of AREA-TAG (2) on the side of AREA-TAG (2) that is opposite to the printing direction; indeed AREA-NORM (1) fully encloses and abuts AREA-TAG (2);
the width of those parts of AREA-NORM (1), which are abutting AREA-TAG (2), is at least 0.1 mm, in one embodiment the width of those parts of AREA-NORM (1), which are abutting AREA-TAG (2), was at least 249 μm, in another embodiment the width of those parts of AREA-NORM (1), which are abutting AREA-TAG (2), was at least 429 μm;
due to said width of at least 0.1 mm both patterns (9) for printing with large-sized tags shown in FIG. 2 and FIG. 3 can be engraved into the gravure printing cylinder in all four directions:
   with the length of AREA-TAG (2) being parallel to the direction of the axis of the gravure printing cylinder with either the side (2-1-4) of AREA-TAG (2) with the lower number of rows of ENGRAVING-NORMs (1-1) abutting AREA-TAG (2) facing in the printing direction or opposite to the printing direction,
   in case that the pattern (9) is engraved with the length of AREA-TAG (2) being perpendicular to the direction of the axis of the gravure printing cylinder, then it can be engraved in both possible directions with respect to the printing direction;
the width of ENGRAVING-NORMs (1-1) is less than 0.4 mm, in one embodiment the width of ENGRAVING-NORMs (1-1) was 83 μm, in another embodiment the width of ENGRAVING-NORMs (1-1) was 143 μm;
the density of ENGRAVING-NORM in the AREA-NORM is more than 6.25 ENGRAVING-NORMs per mm², in one embodiment the density of ENGRAVING-NORM in the AREA-NORM is 49 ENGRAVING-NORMs per mm², in another embodiment the density of ENGRAVING-NORM in the AREA-NORM is 145 ENGRAVING-NORMs per mm²;
the lower limit of the width of ENGRAVING-TAG (2-1) is 0.4 mm, in one embodiment the width of ENGRAVING-TAG (2-1) was 500 μm, in another embodiment the width of ENGRAVING-TAG (2-1) was 750 μm, in another embodiment the width of ENGRAVING-TAG (2-1) was 2 mm;
the lower limit of the length of ENGRAVING-TAG (2-1) is 0.4 mm, in one embodiment the length of ENGRAVING-TAG (2-1) was 2 mm, in another embodiment the length of ENGRAVING-TAG (2-1) was 5 mm.

In FIG. 1, FIG. 2 and FIG. 3,
the width of the wall of ENGRAVING-TAG (2-1) is from 5 to 25 μm, in one embodiment the width of the wall of ENGRAVING-TAG (2-1) was essentially 15 μm;
ENGRAVING-TAG (2-1) and the large pit (2-1-3) of ENGRAVING-TAG (2-1) have same contours, a contour of a rectangle;
the depth of the large pit (2-1-3) is from 15 to 40 μm, in one embodiment the depth of the large pit (2-1-3) was 20 μm, in another embodiment the depth of the large pit (2-1-3) was 25 μm, in another embodiment the depth of the large pit (2-1-3) was 30 μm;

In FIG. 2 and FIG. 3,
the ridges (2-1-2) have the contour of a straight line, are inclined with an angle of from 15° to 75°, in one embodiment the angle was 45°, against the direction of the length of the gravure printing cylinder and have the same width over their entire length, and,
the large pit (2-1-3) contains a plurality ridge (2-1-2);
   all ridges (2-1-2) have the same contour;
   all ridges (2-1-2) have the same angle, so all ridges (2-1-2) run parallel to each other; and
   all ridges (2-1-2) have the same width of at least 10 μm, in one embodiment ridges (2-1-2) had the same width of 30 μm;
   the width of all subpits (2-1-1) which are delimited by two adjacent ridges (2-1-2) are the same and is from 100 to 400 μm, in one embodiment said width was 250 μm, in another embodiment said width was 350 μm;
   the ridges (2-1-2) are distributed evenly over the length of large pit (2-1-3), so that the subpits (2-1-1) which are delimited by two adjacent ridges (2-1-2) have a comparable size and shape.

In FIG. 1, FIG. 2 and FIG. 3,
the wall of ENGRAVING-NORM (1-1) has the essentially same width over its whole length, the width of the wall of ENGRAVING-NORM (1-1) is from 5 to 25 μm, in one embodiment said width was 15 μm;
ENGRAVING-NORM (1-1) and the pit (1-1-1) of ENGRAVING-NORM (1-1) have the essentially same contour, a contour of a square;
one border of the square has an angle, ANG-1 (1-3), against the direction of the length of the gravure printing cylinder of from 0 to 90°, in one embodiment ANG-1 (1-3) was 45°;
the depth of the pit (1-1-1) of ENGRAVING-NORM (1-1) is at least 15 μm, in one embodiment said depth was 25 μm, in one embodiment said depth was 30 μm; and

AREA-NORM (1) contains and is completely filled with a plurality of ENGRAVING-NORMs (1-1) with any two adjacent ENGRAVING-NORMs (1-1) abutting each other, every ENGRAVING-NORM (1-1) has the same width of its wall, contour, ANG-1 (1-3), length, depth and width;

AREA-NORM (1) contains a plurality of straight lines of succession of ENGRAVING-NORMs (1-1) and all ENGRAVING-NORMs (1-1) are part of said straight lines of succession and the direction of any straight line of succession has the same angle, ANG-2 (1-4), against the direction of the length of the gravure printing cylinder of from 0 to 90°, in one embodiment ANG-2 (1-4) was 45°;
all the straight lines of succession are consecutively adjacent and parallel to each other and any two adjacent straight lines of succession abut each other, the distance between the adjacent rims of the walls of the adjacent pits (1-1-1) of two adjacent ENGRAVING-NORMs (1-1), each located in a different of two adjacent straight lines of succession, is from 10 to 50 μm, in one embodiment said distance was 30 μm;
a possible offset between any two adjacent straight lines of succession against each other is defined by ANG-3 (1-5), wherein an imaginary straight line, that is connecting the center points of the contour of a first ENGRAVING-NORM (1-1) in one of two straight lines of succession adjacent to each other with the center point of the contour of a second ENGRAVING-NORM (1-1) adjacent to the first ENGRAVING-NORM (1-1) but located in the other straight line of succession, has ANG-3 (1-5) against the direction of the straight lines of succession, ANG-3 (1-5) is from 45 to 135°, in one embodiment ANG-3 (1-5) was of 90°, so there was no offset between any two adjacent straight lines of succession against each other in this embodiment.

### LIST OF REFERENCE NUMERALS

1 AREA-NORM
1-1 ENGRAVING-NORM
1-1-1 pit of ENGRAVING-NORM
1-2 border of AREA-NORM delimiting the printed area from the non-imprinted area of the surface of the print substrate and from the AREA-TAG
1-3 ANG-1
1-4 ANG-2
1-5 ANG-3
2 AREA-TAG
2-1 ENGRAVING-TAG
2-1-1 subpit
2-1-2 ridge
2-1-3 large pit of ENGRAVING-TAG
2-1-4 side of AREA-TAG along its length with the lower number of rows of ENGRAVING-NORMs abutting AREA-TAG
2-1-5 side of AREA-TAG in the printing direction
2-1-6 side of AREA-TAG opposite to the printing direction
3 unengraved surface of the gravure printing cylinder
4 imprinted area of the gravure printed pattern containing large-sized tags on the print substrate
5 non-imprinted area of the surface of the print substrate
6 large-sized tag in the imprinted area of the gravure printed pattern containing large-sized tags on the print substrate
7 closed two-piece hard capsule shell
7-1 body of the two-piece hard capsule shell
7-2 cap of the two-piece hard capsule shell
8 printing direction of print substrate
9 pattern for printing with large-sized tags containing AREA-NORM with ENGRAVING-NORM and AREA-TAG with ENGRAVING-TAG engraved in the surface of the gravure printing cylinder, engraved pattern
10 gravure printed pattern containing large-sized tags, printed pattern
11 gravure printing cylinder
11-1 axis of gravure printing cylinder
11-2 printing direction of the gravure printing cylinder
12 print substrate
12-1 printing direction of the print substrate

1. A gravure printing cylinder (11) for printing a gravure printed pattern (10) containing large-sized tags onto a surface of a print substrate (12);
the pattern to be gravure printed is engraved into the surface of the gravure printing cylinder (11) as an engraved pattern (9) comprising two areas,
an area for gravure printing, AREA-NORM (1), and
an area for gravure printing of large-sized tags, AREA-TAG (2);
AREA-NORM (1) is an area which is delimited by its border (1-2);
AREA-TAG (2) is an area which is delimited by its border;
AREA-NORM (1) comprises an engraving, ENGRAVING-NORM (1-1);
AREA-TAG (2) comprises an engraving, ENGRAVING-TAG (2-1);
ENGRAVING-NORM (1-1) is a pit (1-1-1) and its surrounding wall, the pit (1-1-1) is engraved into the surface of the gravure printing cylinder (11) leaving its surrounding wall unengraved, with the top of the wall being on the same level as the unengraved surface (3) of the gravure printing cylinder (11);
the length of ENGRAVING-NORM (1-1) is the length in the direction of the largest lateral extension of ENGRAVING-NORM (1-1);
the width of ENGRAVING-NORM (1-1) is the largest lateral extension of ENGRAVING-NORM (1-1) perpendicular to its length;
the length of ENGRAVING-NORM (1-1) is equal to or larger than its width;
ENGRAVING-TAG (2-1) is a large pit (2-1-3) and its surrounding wall, the large pit (2-1-3) is engraved into the surface of the gravure printing cylinder (11) leaving its surrounding wall unengraved, with the top of the wall being on the same level as the unengraved surface (3) of the gravure printing cylinder (11);
the length of ENGRAVING-TAG (2-1) is the length in the direction of the largest lateral extension of ENGRAVING-TAG (2-1);
the width of ENGRAVING-TAG (2-1) is the largest lateral extension of ENGRAVING-TAG (2-1) perpendicular to its length;
the length of ENGRAVING-TAG (2-1) is equal to or larger than its width;
the length of the large pit (2-1-3) of ENGRAVING-TAG (2-1) is the length in the direction of the largest lateral extension of the large pit (2-1-3) of ENGRAVING-TAG (2-1);
the width of the large pit (2-1-3) of ENGRAVING-TAG (2-1) is the largest lateral extension of the large pit (2-1-3) of ENGRAVING-TAG (2-1) perpendicular to its length;
the length of the large pit (2-1-3) of ENGRAVING-TAG (2-1) is equal to or larger than its width;
any lateral dimension is a dimension in a cylindrical layer coaxial to the unengraved surface (1-2) of the gravure printing cylinder (11);
characterized in that the width of ENGRAVING-NORM (1-1) is less than 0.4 mm;
the lower limit of the width of ENGRAVING-TAG (2-1) is 0.4 mm;
the size of the width of the large pit (2-1-3) of ENGRAVING-TAG (2-1) is at least 50% of the size of the width of ENGRAVING-TAG (2-1);
at least all the parts of the border of AREA-TAG (2) on the side (2-1-6) of AREA-TAG (2) that is opposite to the printing direction (11-2) abut a part of the border (1-2) of AREA-NORM (1); the printing direction (11-2) is the circumferential direction around the axis (11-1) of the gravure printing cylinder (11) in which the gravure printing cylinder (11) revolves when printing.

2. The gravure printing cylinder (11) according to claim 1, wherein
AREA-NORM (1) has a plurality of ENGRAVING-NORM (1-1) and AREA-NORM (1) is completely filled with a plurality of ENGRAVING-NORMs (1-1) with any two adjacent ENGRAVING-NORMS (1-1) abutting each other.

3. The gravure printing cylinder (11) according to claim 1, wherein
the contour of ENGRAVING-NORM (1-1) is a square and the density of ENGRAVING-NORM (1-1) in the AREA-NORM (1) is more than 6.25 ENGRAVING-NORMs (1-1) per mm²;
preferably from 6.25 to 1'111 ENGRAVING-NORMs (1-1) per mm², more preferably from 11 to 1'111 ENGRAVING-NORMS (1-1) per mm², even more preferably from 25 to 1'111 ENGRAVING-NORMs (1-1) per mm², especially from 39 to 278 ENGRAVING-NORMS (1-1) per mm², more especially from 44 to 204 ENGRAVING-NORMs (1-1) per mm², even more especially from 48 to 178 ENGRAVING-NORMs (1-1) per mm².

4. The gravure printing cylinder (11) according to claim 1, wherein AREA-TAG (2) has only one ENGRAVING-TAG (2-1) and the area of ENGRAVING-TAG (2-1) and the area of AREA-TAG (2) are identical.

5. The gravure printing cylinder (11) according to claim 1, wherein AREA-NORM (1) fully encloses and abuts AREA-TAG (2).

6. The gravure printing cylinder (11) according to claim 1, wherein any width of AREA-NORM (1) is at least 0.1 mm, preferably at least 0.2 mm.

7. The gravure printing cylinder (11) according to claim 1, wherein
the width and the length of the wall of ENGRAVING-TAG (2-1) are lateral dimensions, the width is perpendicular to the length and is from 5 to 25 μm, preferably from 10 to 20 μm, more preferably from 12.5 to 17.5 μm.

8. The gravure printing cylinder (11) according to claim 1, wherein
ENGRAVING-TAG (2-1) and the large pit (2-1-3) of ENGRAVING-TAG (2-1) have the same contours, preferably of a rectangle.

9. The gravure printing cylinder (11) according to claim 1, wherein
ENGRAVING-TAG (2-1) extends with its length in the direction of the axis (11-1) of the gravure printing cylinder (11); whereas the width of ENGRAVING-TAG (2-1) extends circumferentially around the gravure printing cylinder (11).

10. The gravure printing cylinder (11) according to claim 1, wherein
the lower limit of the width of ENGRAVING-TAG (2-1) is 0.45 mm or 0.6 mm or 0.7 mm;
preferably, the width of ENGRAVING-TAG (2-1) is from 0.4 to 3 mm, more preferably from 0.4 to 2.5 mm, even more preferably from 0.4 to 2.25 mm, especially from 0.4 to 2.1 mm.

11. The gravure printing cylinder (11) according to claim 1, wherein
when the length of the large pit (2-1-3), that is its largest longitudinal extension from one wall to the opposite wall delimiting the large pit (2-1-3), is 500 μm or larger, then the large pit (2-1-3) contains at least one ridge (2-1-2);
a ridge (2-1-2) is an area within the large pit (2-1-3) which is engraved to a depth of at most 258, preferably at most 20%, more preferably at most 158, even more preferably at most 10%, especially at most 5%, of the depth of the large pit (2-1-3), especially a ridge (2-1-2) is an area within the large pit (2-1-3) which is not engraved.

12. The gravure printing cylinder (11) according to claim 11, wherein
the ridge (2-1-2) extends through the large pit (2-1-3) from one point of the wall of the large pit (2-1-3) to a point of the wall on the other side of the large pit (2-1-3);
a ridge (2-1-2) divides the large pit (2-1-3) into subpits (2-1-1).

13. The gravure printing cylinder (11) according to claim 11 or 12, wherein
a ridge (2-1-2) has the contour of a straight line and it is inclined with an angle against the direction of the length of the gravure printing cylinder (11);
preferably, the angle of a ridge (2-1-2) is from 15 to 75°, more preferably from 25 to 65°, more preferably from 35 to 55°, even more preferably from 40 to 50°.

14. The gravure printing cylinder (11) according to claim 11, wherein
if the large pit (2-1-3) contains more than one ridge (2-1-2), then all ridges (2-1-2) have the same contour; and/or
a ridge (2-1-2) has the same width over its entire length; and/or
the width of a ridge (2-1-2) is at least 10 μm, more preferably at least 20 μm, even more preferably at least 25 μm; and/or
the width of a ridge (2-1-2) is from 10 to 50 μm, preferably from 20 to 40 μm, more preferably from 25 to 35 μm; and/or
in case of when the large pit (2-1-3) contains more than one ridge (2-1-2) then all ridges (2-1-2) have the same width.

15. The gravure printing cylinder (11) according to claim 11, wherein
when the large pit (2-1-3) contains only one ridge (2-1-2), then this ridge (2-1-2) is centered in the large pit (2-1-3) and divides the large pit (2-1-3) into two subpits (2-1-1) with comparable size, shape and width;
when the large pit (2-1-3) contains more than one ridge (2-1-2) which run parallel to each other and have the same width, then the width of the subpits (2-1-1) between any two adjacent ridges (2-1-2), that is the distance of the midpoints of the widths of the two adjacent ridges (2-1-2), are the same.

16. The gravure printing cylinder (11) according to claim 1, wherein
the wall of ENGRAVING-NORM (1-1) has the essentially same width in lateral direction over its whole length;
the width and the length of the wall of ENGRAVING-NORM (1-1) are lateral dimensions, the width is perpendicular to the length and is preferably from 5 to 25 μm, more preferably from 10 to 20 μm, even more preferably from 12.5 to 17.5 μm.

17. The gravure printing cylinder (11) according to claim 1, wherein
ENGRAVING-NORM (1-1) and the pit (1-1-1) of ENGRAVING-NORM (1-1) have same contours or at least essentially same contours, preferably of a square, of a circle or of a line;
preferably, when the contour is a line then it is a straight line;
preferably, in case of a plurality of ENGRAVING-NORM (1-1) in AREA-NORM (1), each ENGRAVING-NORM (1-1) has the same contour or at least essentially same contour.

18. The gravure printing cylinder (11) according to claim 1, wherein
ENGRAVING-NORM (1-1) has a width of from 30 to less than 400 μm, preferably of from 30 to 300 μm, more preferably of from 30 to 200 μm, especially of from 60 to 160 μm, more especially of from 70 to 150 μm, even more especially of from 75 to 145 μm; and/or
in case of a plurality of ENGRAVING-NORM (1-1) in AREA-NORM (1), each ENGRAVING-NORM (1-1) has the same width.

19. A method for engraving a pattern (9) for printing with large-sized tags containing AREA-NORM (1) with ENGRAVING-NORM (1-1) and AREA-TAG (2) with ENGRAVING-TAG (2-1) into the surface of the gravure printing cylinder (11), wherein
the pit (1-1-1) of ENGRAVING-NORM (1-1) and the large pit (2-1-3) of ENGRAVING-TAG (2-1) are engraved into the surface of the gravure printing cylinder (11);
the engraving is done by mechanical, chemical or optical engraving;
preferably, the engraving is done by optical engraving, more preferably, by laser engraving;
with AREA-NORM (1), ENGRAVING-NORM (1-1), AREA-TAG (2), ENGRAVING-TAG (2-1) and the gravure printing cylinder (11).

20. A method for gravure printing a pattern (10) containing large-sized tags onto the surface of a print substrate (12), wherein
the print substrate (12) is a two-piece hard capsule shell (7) or a body (7-1) or a cap (7-2) of a two-piece hard capsule shell (7);
the gravure printing is done with the gravure printing cylinder (11),
employing a gravure printing ink containing large-sized tags;
preferably the sizes of the large-sized tags are from 20 to 150 μm;
preferably the large-sized tags are chemically silicon dioxide;
preferably the gravure printing ink is a solvent based gravure printing ink.

21. A print substrate (12) with a gravure printed pattern (10) containing large-sized tags gravure printed on its surface;
the print substrate (12) is a two-piece hard capsule shell (7) or a body (7-1) or a cap (7-2) of a two-piece hard capsule shell (7);
the gravure printed pattern (10) containing large-sized tags is obtainable by gravure printing with the gravure printing cylinder (11) as defined in claim 1;
preferably the sizes of the large-sized tags are from 20 to 150 μm;
preferably the large-sized tags are chemically silicon dioxide;
preferably, the print substrate (12) is a body or a cap of a two-piece hard capsule shell (7), or a tablet.
